(19) United States
(12) Patent Application Publication
(10) Pub. No.: US 2015/0075251 A1
(43) Pub. Date: Mar. 19, 2015

(54) DETECTING PRESSURE SENSOR OFFSET IN A PHEV FUEL TANK

(71) Applicant: FORD GLOBAL TECHNOLOGIES, LLC, DEARBORN, MI (US)

(72) Inventors: ROBERT ROY JENTZ, Westland, MI (US); AED M. DUDAR, Canton, MI (US)

(73) Assignee: FORD GLOBAL TECHNOLOGIES, LLC, DEARBORN, MI (US)

(21) Appl. No.: 14/027,281

(22) Filed: Sep. 16, 2013

(51) Int. Cl. G01L 27/00

(52) U.S. Cl. CPC G01L 27/002
USPC 73/1.63

(57) ABSTRACT

A method for determining pressure sensor offset values in an evaporative emission control system. The method is performed during initial vehicle power up, and the method begins by receiving a reference signal indicating existing atmospheric pressure, as well as a check signal from a fuel tank pressure sensor indicating pressure within the fuel tank, at a time when the fuel system is open to atmosphere. A controller then calculates a sensor offset value based upon the reference signal and the check signal, and the controller stores the sensor offset value in a system memory location. During operation of the evaporative emission control system, the controller modifies pressure values received from the fuel tank pressure sensor by applying the sensor offset value. Whenever the system employs a reading from the fuel tank pressure sensor, that reading is corrected by applying the stored offset value.

### TECHNICAL FIELD

Embodiments of the present disclosure generally relate to Evaporative Emission Control Systems (EVAP) for automotive vehicles, and, more specifically, to improvements in pressure sensors installed within the fuel-tanks of Plug-in Hybrid Electric Vehicles (PHEVs) that incorporate EVAP systems.

### BACKGROUND

Automotive fuel, primarily gasoline, is a volatile liquid subject to potentially rapid evaporation. Thus, the fuel contained in automobile gas tanks presents a major source of potential evaporative emission of hydrocarbons into the atmosphere. Industry's response to this potential problem has been the incorporation of the evaporative emission control systems into automobiles. These systems are described in more detail below, but generally, they rely upon a canister charged with activated carbon pellets connected to the fuel tank. The pellets absorb fuel vapor, and periodically, the canister is purged by routing fresh air through the canister to the intake manifold. Fuel vapor is entrained by the airflow, and the mixture then proceeds into the engine where it is combusted.

Hybrid electric vehicles, including plug-in hybrid electric vehicles (HEV's or PHEV's), pose a particular problem for effectively controlling evaporative emissions with this kind of system. Although hybrid vehicles have been proposed and introduced having a number of forms, these designs share the characteristic of providing a combustion engine as backup to an electric motor. Primary power is provided by the electric motor, and careful attention to charging cycles can result in an operating profile in which the engine is only run for short periods. Systems in which the engine is only operated once or twice every few weeks are not uncommon. Purging the carbon canister can only occur when the engine is running, of course, and if the canister is not purged, the carbon pellets can become saturated, after which hydrocarbons will escape to the atmosphere, causing pollution.

PHEVs have sealed fuel-tanks, designed to withstand differences in pressure and vacuum within the tank resulting from ambient temperature variations. A fuel-tank pressure transducer (FTPT), which is a high-pressure sensor, is generally mounted within the tank's interior to monitor fuel system pressure.

Every FTPT varies slightly from perfect accuracy, and that variation is referred to as a sensor offset. Such inherent inaccuracy may be as great as 3.5%. Without correction, that inaccuracy can result in unreliable operation of the evaporative emission control system.

In conventional gasoline or diesel vehicles fuel-tank vents facilitate sensor offset determination, which is established usually after a prolonged vehicle halt, before an ignition. PHEV fuel-tanks, being sealed, present a greater challenge.

Typically, determining the FTPT offset requires either an extended period or runs the risk of venting hydrocarbons to the atmosphere. One method requires the vehicle to remain stationary for an extended period, until the system cools sufficiently for the FTPT to return a zero reading. At that point, true atmospheric pressure can be measured, the difference between true atmospheric and the FTPT reading being the FTPT offset. Not only does that process require considerable time, but a number of readings must be taken to catch the FTPT at exactly zero. Otherwise, measuring a sensor offset requires tank venting, which almost inevitably releases hydrocarbons into the atmosphere. Alternatively, sensor offsets may be learned during refueling, but that has been observed to produce erroneous results, as that operation introduces severe system pressure variations in the internal pressure. In effect, the current circumstances provide an inappropriate platform to gather accurate sensor offset information.

Options to determine sensor offset information more accurately thus remain open.

### SUMMARY

The present disclosure provides a method for determining a pressure sensor offset value in an evaporative emission control system.

One aspect of the present disclosure relates to a method for determining pressure sensor offset values in an evaporative emission control system. The method is performed during initial vehicle power up, and the method begins by receiving a reference signal indicating existing atmospheric pressure, as well as a check signal from a fuel tank pressure sensor indicating pressure within the fuel tank, at a time when the fuel system is open to atmosphere. A controller then calculates a sensor offset value based upon the reference signal and the check signal, and the controller stores the sensor offset value in a system memory location. During operation of the evaporative emission control system, the controller modifies pressure values received from the fuel tank pressure sensor by applying the sensor offset value.

Another aspect of the present disclosure is a method for correcting a stored pressure sensor offset value in an evaporative emission control system. First, the method determines a fuel tank pressure fall off rate, based on at least two fuel tank pressure measurements, the pressure measurements being offset by the stored pressure sensor offset value. Then, the method calculates a predicted fuel tank pressure value at a selected time, based on the fuel tank pressure fall off rate. An existing fuel tank pressure value is then determined at the selected time, and an actual pressure value within the fuel tank is calculated using the stored pressure offset value. Finally, the method corrects the stored pressure sensor offset value by an amount corresponding to any difference between the predicted fuel tank pressure value an actual fuel tank pressure value.

Additional aspects, advantages, features and objects of the present disclosure would be made apparent from the drawings and the detailed description of the illustrative embodiments construed in conjunction with the appended claims that follow.

### BRIEF DESCRIPTION OF THE DRAWINGS

The figures described below set out and illustrate a number of exemplary embodiments of the disclosure. Throughout the drawings, like reference numerals refer to identical or functionally similar elements. The drawings are illustrative in nature and are not drawn to scale.

FIG. 1 is a schematic view of an exemplary EVAP system installed in a PHEV.

FIG. 2 is a flowchart illustrating an exemplary method for gathering a pressure sensor offset value in an evaporative emission control system, according to the present disclosure.

FIG. 3 is a flowchart depicting an exemplary method to correct a stored pressure sensor offset value in an evaporative emission control system.

### DETAILED DESCRIPTION

The following detailed description is made with reference to the figures. Exemplary embodiments are described to illustrate the subject matter of the disclosure, not to limit its scope, which is defined by the appended claims.

Overview

In general, the present disclosure describes a method for determining pressure sensor offset values in an evaporative emission control system in a vehicle. To this end, sensor offset information is obtained during vehicle assembly, at the initial vehicle power-up and before initial refueling. At that point, a powertrain control module (PCM) gathers sensor offset information and stores that within a memory in the vehicle control system. From that point forward, the PCM can apply a sensor offset value during EVAP leak detection and refueling procedures, increasing the accuracy of those readings.

Exemplary Embodiments

The following detailed description illustrates aspects of the disclosure and its implementation. This description should not be understood as defining or limiting the scope of the present disclosure, however, such definition or limitation being solely contained in the claims appended hereto. Although the best mode of carrying out the invention has been disclosed, those in the art would recognize that other embodiments for carrying out or practicing the invention are also possible.

The system set out below proposes a method to determine inherent inaccuracies in PHEV fuel-tank pressure sensors before the vehicle leaves the manufacturing plant. That information is stored in system memory, and it is used during later operation. Throughout this in and in and application, sensor inaccuracies may be interchangeably referred to as sensor offsets.

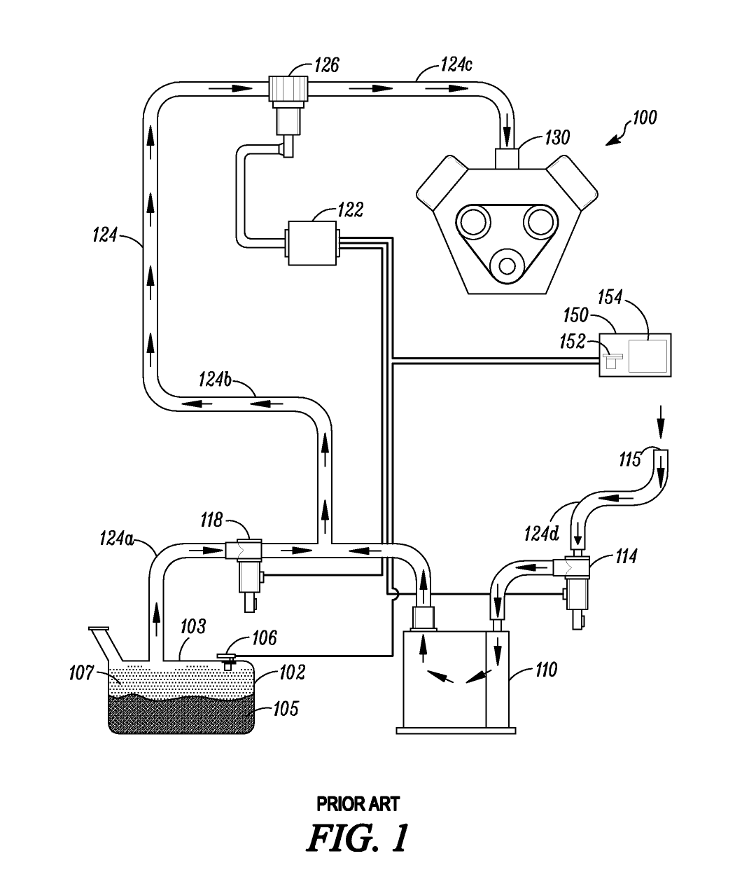

FIG. 1 illustrates a conventional evaporative emissions control system 100. As seen there, the system 100 is made up primarily of the fuel tank 102, a carbon canister 110, and the engine intake manifold 130, all operably connected by lines and valves 105. It will be understood that many variations on this busy design are possible, but the illustrated embodiment follows the general practice of the art. It will be further understood that the system 100 is generally sealed, with no open vent to atmosphere.

Fuel tank 102 is partially filled with liquid fuel 105, but a portion of the liquid will evaporate over time, producing fuel vapor 107 in the upper portion (vapor dome 103) of the tank. The amount of vapor produced will depend upon a number of environmental variables, such as the ambient temperature. Of these factors, temperature is probably the most important, given the temperature variation produced in the typical diurnal temperature cycle. For vehicles in a warm climate, particularly a hot, sunny climate, the heat produced by leaving a vehicle standing in direct sunlight can produce very high pressure within the vapor dome 103 of the tank 102. A pressure sensor 106, known as the FTPT, monitors the pressure in the fuel tank vapor dome 103.

Vapor lines 124 join the various components of the system. One portion of that line, line 124a runs from the fuel tank 102 to carbon canister 110. A normally closed valve 118 regulates the flow of vapor from fuel tank 102 to the carbon canister 110, so that vapor generated by evaporating fuel can be adsorbed by the carbon pellets under control of a PCM 122. Vapor line 124b joins line 124a in a T intersection beyond valve 118, connecting that line with a normally closed canister purge valve (CPV) 126. Line 124c continues from CPV 126 to the engine intake manifold 130. CPV 126 is controlled by signals from the powertrain control module (PCM) 122, which also controls valve 118.

Canister 110 is connected to ambient atmosphere at vent 115, through a normally closed valve 114. Vapor line 124d connects that 115 in canister 110. Valve 114 is controlled by PCM 122.

During normal operation, valve 118 is open, while valves 126 and 114 are closed. When pressure within vapor dome 103 rises sufficiently, under the influence, for example, of increased ambient temperature, the PCM opens valve 118, allowing vapor to flow to the canister, where carbon pellets can adsorb fuel vapor.

To purge the canister 110, valve 118 is closed, and valves 126 and 114 are opened. It should be understood that this operation is only performed when the engine is running, which produces a vacuum at intake manifold 130. That vacuum causes an airflow from ambient atmosphere through vent 115, canister 110, and CPV 126, and then onward into the intake manifold 130. As the airflow passes through canister 110, it entrains fuel vapor from the carbon pellets. The fuel vapor mixture then proceeds to the engine, where it is mixed with the primary fuel/air flow to the engine for combustion, and therefore, is utilized, preventing its release into the atmosphere.

FTPT 106 is operably connected to the PCM 122 and is mounted suitably within the interior of the fuel tank 102. FTPT 106 may be chosen from among the devices widely known and available to the art. As noted, the fuel tank 102 is generally under pressure or vacuum owing to the drive/diurnal cycle. As a result, the sensor readings fluctuate around the atmospheric value. As will be clear from the discussion below, determining the FTPT offset requires a device in addition to the components incorporated in the vehicle evaporative emission control system. Here, an external controller 150 is provided, with connections to FTPT 106 and PCM 122. Controller 150 includes a reference pressure sensor 152 and control unit 154. Reference pressure sensor 152 can be a highly accurate pressure sensor, and control unit 154 can be any computing device capable of receiving pressure inputs, calculating the difference between the inputs, and outputting that difference as an offset value. In one embodiment, control unit 154 can be a laptop computer, appropriately programmed, and controller 150 can include appropriate interconnections.

Controller 150 receives two inputs. A first input is provided directly from FTPT 106, indicating that device's reading of the pressure within vapor dome 103. A second input originates at reference sensor 152, indicating atmospheric pressure. Control unit 154 calculates the difference between the FTPT reading and true atmospheric pressure, and it then stores that difference as the sensor offset. The storage location can be any convenient memory location in the automobile system, accessible by the PCM 122. Appropriate interconnections can be provided to connect controller 150 to PCM 122 and FTPT 106.

In some embodiments, PCM 122 may include a controller (not shown) of a known type connected to the FTPT 106 and the reference sensor 152. Other sensors may be connected as well. The controller may be of a known type, forming one part of the system hardware, and it may be a microprocessor-based device that includes a central processing unit (CPU) for processing incoming signals from known source. The controller may be provided with volatile memory units, such as a RAM and/or ROM that function along with associated input and output buses. Further, the controller may also be optionally configured as an application specific integrated circuit, or may be formed through other logic devices that are well known to the skilled in the art. More particularly, the controller may be formed either as a portion of an existing electronic controller, or may be configured as a stand-alone entity.

In an alternative embodiment, PCM 122 may be programmed to perform the calculations required to determine the sensor offset value. In that embodiment, PCM 122 is operatively connected to reference sensor 152, in addition to the already existing connection to FTPT 106. The PCM can then operate as discussed below to determine and stored the sensor offset.

The controller may include a memory where information can be stored for periodic retrieval. There, a calculating module (not shown) may be configured, and alongside, algorithm(s) may be installed to carry out specific functions. More particularly, the installed algorithm(s) may be configured to predict a pressure reading inside the fuel tank 102, at a selected time, based on an initial pressure determined by the pressure sensor 106. Additionally, a timer (not shown) may operate along with the PCM 122 to facilitate the algorithmic pressure output predictions.

The one time and location where the operation set out above can be undertaken without danger of venting hydrocarbons to the atmosphere occurs at the end of the vehicle assembly, before initial refueling. At that point, all components of the evaporative emission control system are installed, yet the fuel tank is empty, preventing any fuel vapor discharge. The process set out below takes advantage of that opportunity.

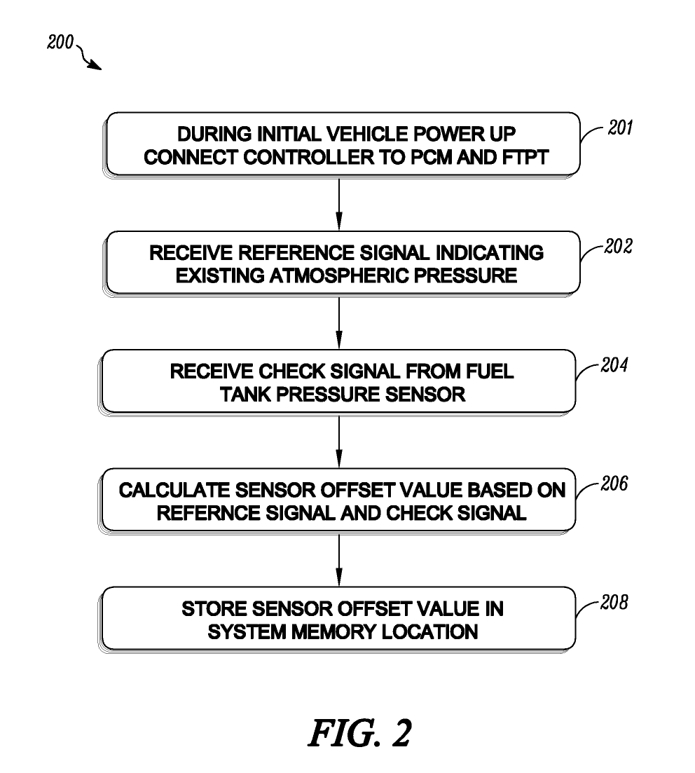

In light of the previous discussion, the disclosure set out below describes an exemplary method of operation of the system 100 for determining and storing a sensor offset value. FIG. 2 is a flowchart 200 setting out that process. Understandably, the method is discussed in connection with FIG. 1.

One embodiment of the present method takes advantage of the opportunity described above. Thus, step 201 is performed during automotive assembly, at a point where the components of the evaporative emission control system, as well as the fuel tank have been assembled, yet before fuel is added to the fuel tank. A convenient point for this operation during the manufacturing process occurs toward the conclusion of the vehicle assembly, at the initial power up of the vehicle, just before fuel is added to the tank.

At that point, the vehicle under test is connected to controller 150. As described above, one connection is made to PCM 122 and another to FTPT 106.

Then, at step 202, the reference sensor 152, connected externally to the system 100, senses and indicates an atmospheric pressure value. Step 204 involves receiving a similar signal from FTPT 106.

In some embodiments, the atmospheric pressure and FTPT signals are both provided directly to PCM 122, while other embodiments route those signals to control unit 152. Those inputs are employed either by the control unit 152 or PCM 122 to calculate the sensor offset value, as a difference between the two signals, at step 206. That offset value is stored for future use in system memory, at step 208.

In some embodiments, the present disclosure directs procedures, such as refueling and EVAP leak detection, to exploit provisions of a stored sensor offset value. More often than not, that avoids forcible system venting to correct the offset values, consequently preventing the release of hydrocarbon into the atmosphere.

As an example, a failure to accurately learn the sensor offset value can result in refueling difficulties. Typically, refueling requests in PHEVs are initiated by a request interface found on the vehicle's dashboard. Upon its activation, a fuel tank isolation valve (FTIV) opens to atmosphere, allowing the tank to equilibrate to atmospheric level. Ideally, the pressure sensor 106 signals when atmospheric pressure is reached, but given the inherent offset, pressure sensors are observed to communicate pressure values inaccurately. Only when pressure sensor 106 detects atmospheric conditions within the tank 102 does the system 100 allow a refueling door to be unlocked. An uncorrected sensor shift will not allow the FTPT to reach atmospheric pressure, causing the refueling door to remain undesirably unlocked. A negative sensor offset, on the other hand, may unlock the refueling door, but may cause the existing fuel within the fuel tank to dangerously surge out.

Likewise, a failure to correct sensor offsets may increase false flag generation (commonly referred to as alpha/beta error) during EVAP leak detection and monitoring procedures. In response, during operation of the evaporative emission control system (EVAP), pressure values received from the fuel tank pressure sensor may be modified by applying the acquired sensor offset value.

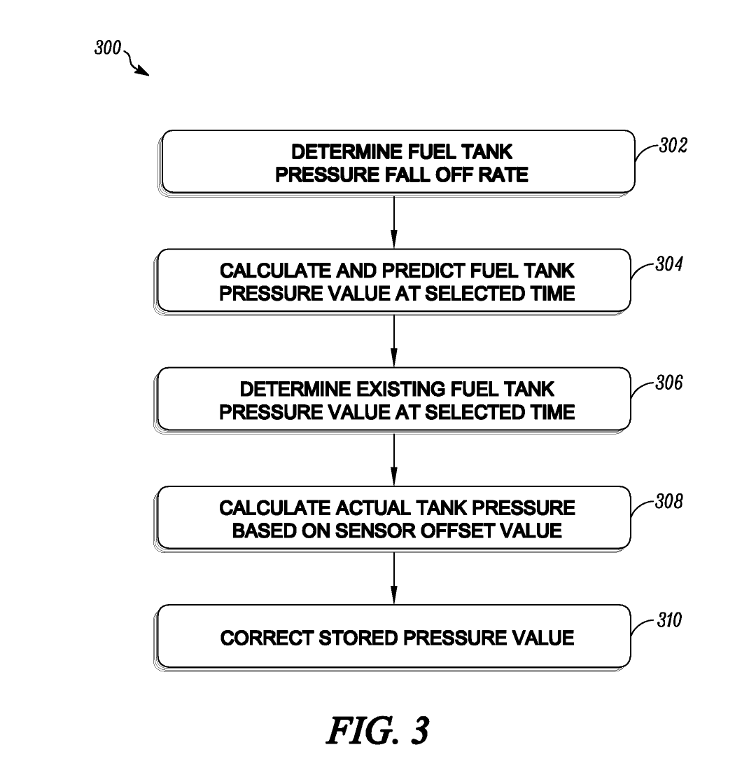

An exemplary method to correct offset values, therefore, is set out through a flowchart 300 in FIG. 3, and is described below. As noted above, the method described bears close resemblance to a preferred working embodiment of the system 100.

Accordingly, at a first stage 302, the PCM 122 determines the fuel tank's pressure fall off rate. Those rates may be understood as the value by which the pressure drips, subject to a vehicular halt, relative to time. To gather that data, exemplarily, at least two fuel tank pressure measurements are noted, one after the other, establishing a time gap between them. Suitable algorithms installed within the PCM 122 can acquire such pressure fall rates. At a next stage 304, the calculating module may calculate and predict a selected time by when the pressure within the fuel tank must subside to match the atmospheric pressure conditions. Subsequently, at stage 306, the pressure sensor 106 determines an existing pressure within the fuel tank at the selected time. That determination is however subject to correction given the sensor's inherent offset. To avoid an erroneous reading, therefore, the calculating module utilizes the stored sensor offset information in the system memory to calculate actual pressure conditions within the fuel tank 102. That occurs and constitutes stage 308.

In one example, if the stored pressure offset value is 0.5 InH₂O, and the read pressure value is 1.5 InH₂O, the calculating module subtracts the offset value from the existing value, and delivers a 1 InH₂O reading as the corrected and actual pressure value existing within the fuel tank 102.

Based on that output, and the stored pressure offset value, the system corrects the stored pressure sensor offset value by an amount that corresponds to a difference between the predicted fuel tank pressure value and an actual fuel tank pressure value, at a final stage 310. Operations such as a fuel lid opening request can then be initiated.

As an example to the above discussion, if the PCM 122 first reads the tank pressure as 10 InH₂O, and 30 minute later, as 5 In H₂O, the PCM 122 will reschedule another reading after another 30 minutes, anticipating a reduction and/or equalization of the fuel tank's internal pressure to the atmospheric pressure, at that rescheduled time. Having an initial pressure determined, therefore, an approximate pressure sensor reading of a later period is established, and the offset value is suitably corrected then. Advantageously, once stored in the PCM memory, the offset value can be corrected periodically based on a timing strategy configured within the PCM 122 for the EVAP leak detection procedures.

Differing configurations of the system 100 may not restrict the PCM's usability as through known mechanisms someone skilled in the art may form embodiments apart from those described. In effect, despite the system's customization and/or variation to any known extent, those skilled in art can ascertain ways to incorporate the PCM 122.

The discussed system 100 may be applied to a variety of other applications as well. For example, any similar application, requiring the adherence to stringent emission norms may make use of the disclosed subject matter. Accordingly, it may be well known to those in the art that the description of the present disclosure may be applicable to a variety of other environments as well, and thus, the environment disclosed here must be viewed as being purely exemplary in nature.

Further, the system 100 discussed so far is not limited to the disclosed embodiments alone, as those skilled in the art may envision multiple embodiments, variations, and alterations, to what has been described. Accordingly, none of the embodiments disclosed herein need to be viewed as being strictly restricted to the structure, configuration, and arrangement alone. Moreover, certain components described in the application may function independently of each other as well, and thus none of the implementations needs to be seen as limiting in any way.

Accordingly, those skilled in the art will understand that variations in these embodiments will naturally occur in the course of embodying the subject matter of the disclosure in specific implementations and environments. It will further be understood that such variations will fall within the scope of the disclosure. Neither those possible variations nor the specific examples disclosed above are set out to limit the scope of the disclosure. Rather, the scope of claimed subject matter is defined solely by the claims set out below.

We claim:

1. A method for determining pressure sensor offset values in an evaporative emission control system, comprising:
during initial vehicle power up,
receiving a reference signal indicating existing atmospheric pressure;
further receiving a check signal from a fuel tank pressure sensor indicating pressure within the fuel tank, at a time when the fuel system is open to atmosphere;
calculating a sensor offset value based upon the reference signal and the check signal; and
storing the sensor offset value in a system memory location;
during operation of the evaporative emission control system, modifying pressure values received from the fuel tank pressure sensor by applying the sensor offset value.

2. The method of claim 1, wherein the fuel tank pressure sensor is a Fuel Tank Pressure Transducer (FTPT).

3. The method of claim 1 further comprising a reference pressure sensor to sense the reference signal.

4. The method of claim 3 further comprising a controller connected to the pressure sensor to establish pressure values determined by the reference pressure sensor and the fuel tank pressure sensor, the controller also including the reference pressure sensor.

5. The method of claim 1 further comprising a Powertrain Control Module (PCM) receiving and storing the reference signal and the check signal.

6. The method of claim 5, wherein the PCM includes:
a calculating module to calculate the sensor offset; and
a memory where the offset value is stored.

7. The method of claim 1, wherein the reference signal is obtained either through a mechanism arranged within the vehicle; or a mechanism arranged outside the vehicle.

8. A method for correcting a stored pressure sensor offset value in an evaporative emission control system, comprising:
determining a fuel tank pressure fall off rate, based on at least two fuel tank pressure measurements, the pressure measurements being offset by the stored pressure sensor offset value;
calculating a predicted fuel tank pressure value at a selected time, based on the fuel tank pressure fall off rate;
determining an existing fuel tank pressure value at the selected time;
calculating an actual pressure value within the fuel tank using the stored pressure offset value; and
correcting the stored pressure sensor offset value by an amount corresponding to any difference between the predicted fuel tank pressure value an actual fuel tank pressure value.

9. The method of claim 8, wherein fuel tank pressure is measured by a pressure sensor, which in turn being connected to a controller and a Powertrain Control Module (PCM), facilitates a corresponding pressure value storage within the PCM.

10. The method of claim 8, wherein predicting the fuel tank pressure value at the selected time is performed by an algorithm installed within the PCM, the PCM correcting the stored pressure sensor offset value based on the predicted fuel tank pressure value.
